(19) United States
(12) Patent Application Publication
(10) Pub. No.: US 2010/0247346 A1
(43) Pub. Date: Sep. 30, 2010

(54) TERMINAL DEVICE FOR ELECTRIC COMPRESSOR

(76) Inventor: Takehiro Hasegawa, Gunma (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/739,582

(22) PCT Filed: Oct. 21, 2008
(86) PCT No.: PCT/JP2008/069037

§ 371 Date: Apr. 23, 2010

(30) Foreign Application Priority Data
Oct. 23, 2007 (JP) 2007-274909

(51) Int. Cl. F04B 35/04; H01R 13/52

(52) U.S. Cl. 417/410.1; 439/271

(57) ABSTRACT

Provided is a terminal device for an electric compressor in which each inputting female terminal of a cluster holding a plurality of inputting female terminals for input into an electric motor built in a compressor in a resin housing is engaged with the inner end of each sealed terminal of a sealed terminal device. The terminal device is characterized in that a resin housing storing section for storing the resin housing is formed in a compressor housing, and in that the resin housing stored in the resin housing storing section is clamped between the compressor housing and a terminal plate of the sealed terminal device mounted on the compressor housing. The terminal device can prevent coming off of the inputting female terminal and undesired positional shifting of the resin housing, and can improve its assembling ability.

### TECHNICAL FIELD OF THE INVENTION

The present invention relates to a terminal device for an electric compressor, and specifically, to improvement of a terminal device for an electric compressor in which power is supplied to a built-in electric motor using a sealed terminal device.

### BACKGROUND ART OF THE INVENTION

A structure is known wherein power is supplied to a built-in electric motor of an electric compressor using a sealed terminal device (also called as a hermetic terminal) (for example, Patent document 1). In this Patent document 1, lengths in the radial direction and in the axial direction of an electric compressor are suppressed small mainly by devising the disposition of inputting terminals.

In a conventional electric compressor, its terminal device is usually constructed as a structure, for example, as shown in FIG. 3. In FIG. 3, symbol 101 indicates a compressor housing, and at a predetermined position of the compressor housing 101, a sealed terminal device 104, in which a plurality of terminals 103 are penetrated through and held on a terminal plate 102 at a sealed and insulated condition (for example, sealed and insulated condition via glass), is mounted. To an inner end of each sealed terminal 103 of this sealed terminal device 104, each inputting female terminal 106 of a cluster 107 holding a plurality of inputting female terminals 106 in a resin housing 105 is electrically connected by fitting. Only by the force of this fitting, resin housing 105 of cluster 107 and inputting female terminals 106 are fixed. From an external power source (not shown), power is supplied to the stator coil of the built-in electric motor through respective sealed terminals 103, respective inputting female terminals 106 and electric wires 108 connected to the inputting female terminals 106.

### DISCLOSURE OF THE INVENTION

### Problems to be Solved by the Invention

The above-described structure of the terminal device is a structure frequently employed for usual domestic electric equipment, and is not particularly considered with respect to vibration resistance. However, in case where an electric compressor is used, in particular, as a compressor for compressing refrigerant used in an air conditioning system for vehicles, a high vibration resistance is required for a terminal device of an electric compressor. As described above, in the structure where resin housing 105 of cluster 107 and inputting female terminals 106 are held and fixed only by fitting respective inputting female terminals 106 to the inner ends of respective sealed terminals 103, when a large vibration is applied, there is a fear that inputting female terminal 106 may come off or that resin housing 105 may shift in position.

Further, in the above-described structure of the conventional terminal device, because the terminal fitting operation must be performed at a condition where resin housing 105 is held by inserting a hand into compressor housing 101, the assembling is not easy, and improvement of the assembling ability is desired.

Accordingly, paying attention to the above-described problems, an object of the present invention is to provide a terminal device of an electric compressor which can prevent coming off of an inputting female terminal and undesired positional shifting of a resin housing and can improve its assembling ability.

### Means for Solving the Problems

To achieve the above-described object, a terminal device for an electric compressor according to the present invention, in which each inputting female terminal of a cluster holding a plurality of inputting female terminals for input into an electric motor built in a compressor in a resin housing is engaged (in particular, fitted) with an inner end of each sealed terminal of a sealed terminal device holding a plurality of terminals on a terminal plate at a condition being sealed and insulated and at a condition being penetrated, is characterized in that a resin housing storing section for storing the resin housing, which has a shape opened toward outside, is formed in a compressor housing, and the resin housing stored in the resin housing storing section is clamped between the compressor housing and the terminal plate of the sealed terminal device mounted on the compressor housing.

In this terminal device of an electric compressor according to the present invention, since the resin housing is stored and assembled in the resin housing storing section formed in a part of the compressor housing and the resin housing is fixed at a predetermined position in the compressor housing by being clamped between the compressor housing and the terminal plate of the sealed terminal device, by this clamping and fixing structure, undesired positional shifting does not occur with the resin housing even when a vibration is applied, and it becomes possible to form a structure wherein the inputting female terminal engaged with the inner end of the sealed terminal does not come off completely. Further, since an aimed clamping and fixing structure of the resin housing is completed by mounting the terminal plate of the sealed terminal device from outside after storing the resin housing in the resin housing storing section having a shape opened toward outside, at the time of assembly it is not necessary to hold the resin housing, positioned in the compressor housing, by hand, and the assembling ability may be greatly improved.

In such a terminal device for an electric compressor according to the present invention, a structure may be employed wherein a height of the resin housing and a depth of the resin housing storing section are set at a substantially same dimension. Because the depth of the resin housing storing section is decided only by a dimensional accuracy of the compressor housing, by employing such a structure, the resin housing stored in the resin housing storing section and attached with the terminal plate of the sealed terminal device on its outside is clamped and fixed at a condition minimized with play, and it may be held and fixed at a desired state more securely.

Further, a structure may be also employed wherein an engaging portion for preventing movement of the resin housing stored in the resin housing storing section is provided in the resin housing storing section. For example, in case where there exists a projected portion on a part of the resin housing, a structure may be employed wherein the engaging portion forms a part of a groove storing the projected portion of the resin housing. In such a structure, by engagement by the engaging portion, movement of the resin housing stored in the resin housing storing section in an undesired direction may be prevented, and the resin housing may be held and fixed at a desired at a desired state more securely.

The terminal device for an electric compressor according to the present invention can be applied to any type compressor in which an electric motor is built. The structure of the terminal device according to the present invention can be applied, of course, to a usual electric compressor having only a compression mechanism driven by the built-in electric motor, and also to a hybrid compressor incorporating a first compression mechanism driven only by the built-in electric motor and a second compression mechanism driven only by an external drive source independently of the first compression mechanism selectively or simultaneously into a single compressor.

Such a terminal device for an electric compressor according to the present invention is effective for use at a place or in an apparatus or a system for which the electric compressor is required especially with a vibration resistance. In particular, it is effective for a case where the electric compressor is a compressor for compressing refrigerant used in an air conditioning system for vehicles, and in this case, because coming off of the inputting female terminal and undesired positional shifting of the resin housing can be securely prevented even when a great vibration is applied from the vehicle side, it becomes possible to greatly increase the reliability of the electric compressor at a condition mounted on the vehicle.

### EFFECT ACCORDING TO THE INVENTION

In the terminal device for an electric compressor according to the present invention, even in case where a great vibration is applied, coming off of the inputting female terminal and undesired positional shifting of the resin housing can be prevented, the portion of the cluster disposed in the compressor housing can be securely held at a desired condition, the function required for the terminal device can be securely maintained, and the assembling ability of the terminal device portion can be greatly improved.

### BRIEF EXPLANATION OF THE DRAWINGS

FIG. 1 is a vertical sectional view of a terminal device for an electric compressor according to an embodiment of the present invention.

FIG. 2 is a side view of the device depicted in FIG. 1, as viewed along II-II line in FIG. 1.

FIG. 3 is a schematic diagram of a conventional terminal device for an electric compressor.

### EXPLANATION OF SYMBOLS

1: electric compressor
2: compressor housing
3: electric motor
4: stator
5: rotor
6: rotational shaft
7: electric wire
8: terminal device
9: terminal plate
10: sealed terminal
11: sealed terminal device
12: cluster
13: inputting female terminal
14: resin housing
15: terminal hole
16: resin housing storing section
17: projected portion
18: groove
19: engaging portion

### THE BEST MODE FOR CARRYING OUT THE INVENTION

Hereinafter, desired embodiments of the present invention will be explained referring to the drawings.

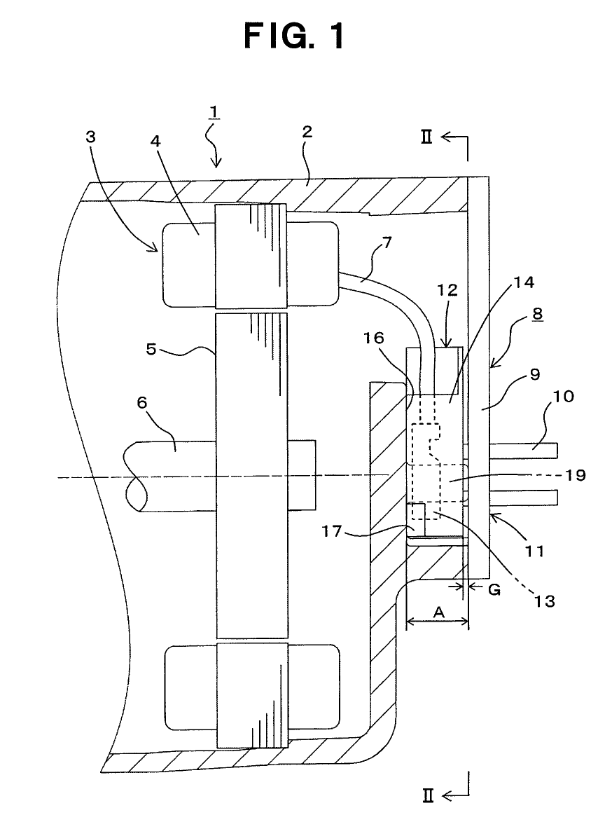

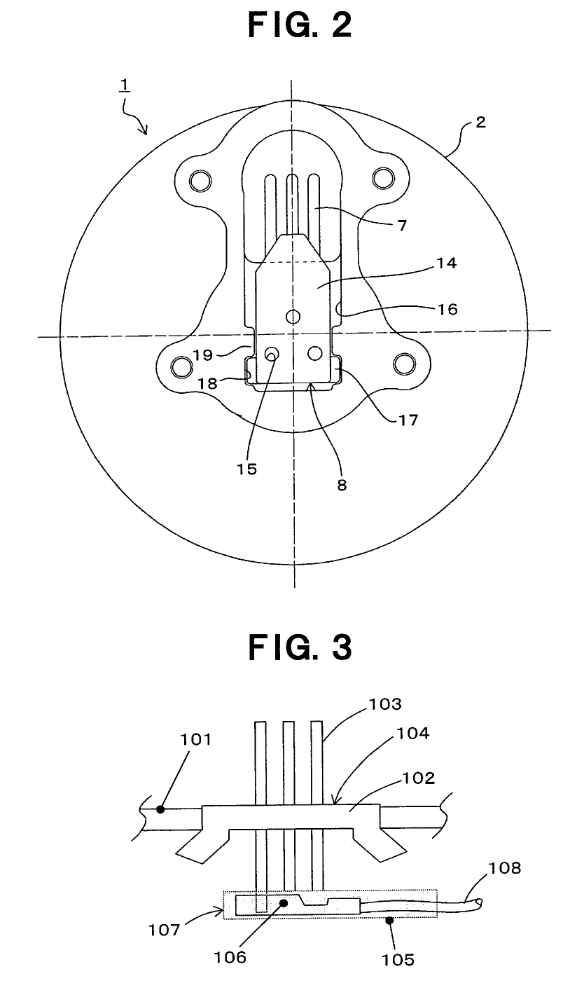

FIGS. 1 and 2 show a terminal device for an electric compressor according to an embodiment of the present invention. In the figures, symbol 1 indicates an electric compressor, and an electric motor 3 is built in a compressor housing 2 of electric compressor 1. Electric motor 3 has a stator 4 and a rotor 5, rotor 5 is secured to a rotational shaft 6 connected to a compression mechanism (not shown), and from stator 4, a plurality of electric wires 7 connected to the coil thereof for power supply (in case of three-phase electric motor, three wires) are pulled out.

In this embodiment, a terminal device 8 for supplying power to electric motor 3 is provided on the side surface side of electric compressor 1, namely, on the outer side surface side of compressor housing 2. However, the present invention can be applied similarly in this embodiment, even to a case where terminal device 8 is provided on the upper surface side of electric compressor 1, namely, on the upper surface side of compressor housing 2 extending in a horizontal direction.

Terminal device 8 has a sealed terminal device 11, in which a plurality of sealed terminals 10 are held on a terminal plate 9 at a condition being sealed and insulated and at a condition being penetrated, and a cluster 12. Cluster 12 comprises a plurality of inputting female terminals 13 (by a number corresponding to the number of sealed terminals 10) fitted to the inner ends of respective sealed terminals 10 and electrically connected thereto, and a resin housing 14 holding therein the inputting female terminals 13, and the above-described electric wires 7 connected to the coil of stator 4 are connected to the respective inputting female terminals 13. Each sealed terminal 10 is inserted into each terminal hole 15 formed on resin housing 14, and the inner end thereof is engaged with corresponding inputting female terminal 13.

In compressor housing 2, a resin housing storing section 16 for storing resin housing 14 is formed, which has a shape opened toward outside (in this embodiment, toward side direction). After resin housing 14 is stored in this resin housing storing section 16 from side direction, terminal plate 9 of sealed terminal device 11 is attached to compressor housing 2 by bolts and the like, and resin housing 14 stored in the resin housing storing section 16 is clamped by compressor housing 2 and terminal plate 9. The depth A of resin housing storing section 16 is set at a substantially same dimension as the height of resin housing 14, and more precisely, the depth A of resin housing storing section 16 is set slightly larger than the height of resin housing 14. Therefore, the gap G between the outer surface of resin housing 14 and the inner surface of terminal plate 9 is kept to be small, and as a result, the play of resin housing 14 stored in and held by resin housing storing section 16 may be minimized.

In this embodiment, projected portions 17 are provided on both sides of the lower portion of resin housing 14 at its assembled condition, and projected portions 17 re stored in grooves 18 formed on both sides of resin housing storing section 16. The parts above these both grooves 18 are formed as engaging portions 19 projected into resin housing storing section 16, and the engaging portions 19 are formed so as to be able to engage with the upper surfaces of projected portions 17 of resin housing 14 which are stored in grooves 18. Via this engagement, the upward movement of resin housing 14 stored in resin housing storing section 16 can be prevented.

In the terminal device for an electric compressor according to this embodiment thus constructed, since resin housing storing section 16 is provided on a part of compressor housing 2, after resin housing 14 is assembled in the storing section 16, terminal plate 9 of sealed terminal device 11 is attached to compressor housing 2 and resin housing 14 is clamped between compressor housing 2 and terminal plate 9, it becomes possible to hold resin housing 14 at a predetermined condition by the clamping, the positional relationship between resin housing 14 and sealed terminal device 11 can be maintained at a predetermined positional relationship, and coming off of inputting female terminal 13 from sealed terminal 10 can be prevented. Further, by storing projected portion 17 of resin housing 14 in groove 18 and engaging projected portion 17 with engaging portion 19, the upward movement of resin housing 14 can be prevented, and undesired positional shifting and coming off of resin housing 14 can be prevented more securely. Therefore, even if a load more than the terminal fitting force is applied between sealed terminal 10 and inputting female terminal 13 by vibration, the inputting female terminal 13 is never gotten off.

Further, by setting the depth A of resin housing storing section at a dimension substantially same as the height of resin housing 14 or slightly larger than that, it may be possible to minimize the play of resin housing 14 stored in and held by resin housing storing section 16. In the conventional structure, although it is possible to decide the disposition height of the resin housing by disposing other parts near the resin housing, because tolerances of other parts themselves or on disposition of other parts are accumulated, it is difficult to make the play small.

Furthermore, as the assembling order, since terminal plate 9 of sealed terminal device 11 can be attached to compressor housing 2 from outside after resin housing 14 is placed in resin housing storing section 16 from outside of compressor housing 2 and held in the storing section 16, it is not necessary to perform terminal fitting while holding the resin housing by inserting a hand into the compressor housing as in the conventional manner, the device can be easily assembled, and it can be achieved to greatly improve the assembling ability.

### INDUSTRIAL APPLICATIONS OF THE INVENTION

The terminal device for an electric compressor according to the present invention can be applied to any type electric compressor required particularly with vibration resistance, and can also be applied to the aforementioned hybrid compressor.

1. A terminal device for an electric compressor in which each inputting female terminal of a cluster holding a plurality of inputting female terminals for input into an electric motor built in a compressor in a resin housing is engaged with an inner end of each sealed terminal of a sealed terminal device holding a plurality of terminals on a terminal plate at a condition being sealed and insulated and at a condition being penetrated, characterized in that a resin housing storing section for storing said resin housing, which has a shape opened toward outside, is formed in a compressor housing, and said resin housing stored in said resin housing storing section is clamped between said compressor housing and said terminal plate of said sealed terminal device mounted on said compressor housing.

2. The terminal device for an electric compressor according to claim 1, wherein a height of said resin housing and a depth of said resin housing storing section are set at a substantially same dimension.

3. The terminal device for an electric compressor according to claim 1, wherein an engaging portion for preventing movement of said resin housing stored in said resin housing storing section is provided in said resin housing storing section.

4. The terminal device for an electric compressor according to claim 3, wherein said engaging portion forms a part of a groove storing a projected portion of said resin housing.

5. The terminal device for an electric compressor according to claim 1, wherein said electric compressor is a compressor having only a compression mechanism driven by said built-in electric motor.

6. The terminal device for an electric compressor according to claim 1, wherein said electric compressor is a hybrid compressor incorporating a first compression mechanism driven only by said built-in electric motor and a second compression mechanism driven only by an external drive source independently from said first compression mechanism selectively or simultaneously into a single compressor.

7. The terminal device for an electric compressor according to claim 1, wherein said electric compressor is a compressor for compressing refrigerant used in an air conditioning system for vehicles.
